(19) United States
(12) Patent Application Publication
(10) Pub. No.: US 2025/0187522 A1
(43) Pub. Date: Jun. 12, 2025

(54) PMD MODULE COUPLING STRUCTURE FOR VEHICLE

(71) Applicants: Hyundai Motor Company, Seoul (KR); Kia Corporation, Seoul (KR)

(72) Inventors: Jae Uk Yun, Busan (KR); Chris Kim, Hwaseong-si (KR); Han Sam Kim, Hwaseong-si (KR)

(21) Appl. No.: 18/760,327

(22) Filed: Jul. 1, 2024

(30) Foreign Application Priority Data
Dec. 11, 2023 (KR) 10-2023-0178253

(51) Int. Cl. B60P 1/64; B66F 3/02; B66F 3/22

(52) U.S. Cl. CPC B60P 1/6445; B66F 3/02; B66F 3/22

(57) ABSTRACT

An embodiment power mobility device (PMD) module coupling structure for a vehicle includes a coupling assembly disposed on a PMD module and a lift assembly disposed on a vehicle body facing an upper end of the PMD module so as to correspond to the coupling assembly, wherein a part of the lift assembly is insertable into the coupling assembly to mutually fix the PMD module and the lift assembly to each other.

### CROSS-REFERENCE TO RELATED APPLICATIONS

This application claims the benefit of Korean Patent Application No. 10-2023-0178253, filed on Dec. 11, 2023, which application is hereby incorporated herein by reference.

### TECHNICAL FIELD

The present invention relates to a power mobility device (PMD) module coupling structure for a vehicle. More particularly, it relates to a PMD module coupling structure for a vehicle configured to provide selective coupling of a PMD module through a coupling structure between a coupling assembly and a lift assembly at least partially inserted into the lift assembly.

### BACKGROUND

Recently, research and development has been actively conducted on technology in which a vehicle using a drone is selectively coupled to a PMD module formed in consideration of the individual purpose of being coupled to a vehicle body and is moved to a location suitable for the purpose of the PMD module.

The PMD module may have various spatial configurations depending on the purpose of use. Further, the PMD module is not configured to be fixed in one location but may be selectively located in a plurality of spaces for various purposes.

Therefore, in order to perform selective coupling between a vehicle body and a PMD module, it is important to provide a coupling structure to perform fixing between the PMD module and the vehicle body.

The related art provides a structure in which a container-type module is coupled to a vehicle using a magnetic coupling structure or hydraulic fixing structure adopted to be coupled to a container corresponding to the PMD module.

However, in the case of using the magnetic coupling structure, it is required to continuously supply power to a magnet. Furthermore, power applied to the magnetic coupling structure rapidly increases depending on the weight of the container, which leads to excessive energy consumption.

Therefore, it is required to provide a mechanical coupling structure for a PMD module connected to a vehicle, and it is also required to provide a structure that enables the vehicle and the PMD module to be coupled to each other at a correct location.

The above information disclosed in this background section is only for enhancement of understanding of the background of embodiments of the invention, and therefore it may contain information that does not form the already known prior art.

Korean Patent Laid-Open Publication No. 10-2023-0078789 may provide information related to the subject matter of the present disclosure.

### SUMMARY

The present invention relates to a PMD module coupling structure for a vehicle. Particular embodiments relate to a PMD module coupling structure for a vehicle configured to provide selective coupling of a PMD module through a coupling structure between a coupling assembly and a lift assembly at least partially inserted into the lift assembly.

Embodiments of the present invention can solve problems associated with the prior art, and embodiments of the present invention provide a mechanical fixing structure through a coupling structure between a coupling assembly and a lift assembly.

Furthermore, embodiments of the present invention provide the lift assembly including a coupling arm at least partially inserted into the coupling assembly and a magnetic unit configured to perform magnetic coupling, thereby achieving a double fixing structure.

Additionally, embodiments of the present invention provide a PMD module coupling structure for a vehicle having a configuration in which, when a lift bar is moved in the upward-and-downward direction by driving of a cylinder, the coupling arm is deployed around a hinge shaft so as to be fixed with the coupling assembly.

The embodiments of the present invention are not limited to the above-mentioned embodiments, and other technical embodiments not mentioned herein will be clearly understood by those skilled in the art to which the present invention pertains from the detailed description of the embodiments. Additionally, the embodiments of the present invention may be achieved by means and combinations thereof as indicated in the claims.

One embodiment of the present invention provides a PMD module coupling structure for a vehicle, the PMD module coupling structure including a coupling assembly located on a PMD module and a lift assembly located on a vehicle body facing an upper end of the PMD module so as to correspond to the coupling assembly, wherein at least a part of the lift assembly is configured to be inserted into the coupling assembly so as to enable the PMD module and the lift assembly to be mutually fixed to each other.

In a preferred embodiment, the lift assembly may include coupling arms, each of the coupling arms being at least partially inserted into the coupling assembly at a location corresponding to the coupling assembly, a frame having the coupling arms respectively located at opposite ends thereof, a connection link configured to move the frame in an upward-and-downward direction, a rack unit located between the connection link and the frame, and a cylinder configured to perform movement in a height direction of the connection link.

In another preferred embodiment, the rack unit may include a rack bracket coupled to the connection link, a lift bar located on the frame and configured to penetrate a guide groove formed in the rack bracket, and a wire located between the lift bar and the coupling arm.

In still another preferred embodiment, the PMD module coupling structure may further include a pinion located at an end of the lift bar penetrating the guide groove and a gear part formed on the rack bracket, wherein the pinion is rotatably moved along the gear part.

In yet another preferred embodiment, the PMD module coupling structure may further include an elastic member located between the coupling arm and the frame and configured to provide elastic force in a direction in which the coupling arm is moved away from the frame.

In still yet another preferred embodiment, the pinion may be rotated, when the cylinder is driven to move the connection link in the height direction, along the gear part in a direction of unwinding the wire.

In a further preferred embodiment, the coupling arm connected to the wire may be rotatably opened around a hinge shaft coupled to the frame.

In another further preferred embodiment, the rack bracket may be rotated so as to have a predetermined angle relative to the frame.

In still another further preferred embodiment, the pinion may be rotated, when the cylinder is driven to reduce a length in the height direction of the connection link, along the gear part in a direction of winding the wire.

In yet another further preferred embodiment, the coupling arms respectively connected to the wires may be rotated around respective hinge shafts coupled to the frame in a direction allowing opposite ends of the coupling arms to be closer to each other.

In still yet another further preferred embodiment, the PMD module coupling structure may further include a magnetic unit adjacent to the coupling arm, the magnetic unit being located on one surface facing the PMD module.

Another embodiment of the present invention provides a PMD module coupling structure for a vehicle, the PMD module coupling structure including a vehicle including a loading space between wheels, a PMD module inserted into the loading space of the vehicle, a coupling assembly located on the PMD module, and a lift assembly located on a vehicle body facing an upper end of the PMD module so as to correspond to the coupling assembly, wherein at least a part of the lift assembly is configured to be inserted into the coupling assembly so as to enable the PMD module and the lift assembly to be mutually fixed to each other.

In a preferred embodiment, the lift assembly may include coupling arms, each of the coupling arms being at least partially inserted into the coupling assembly at a location corresponding to the coupling assembly, a frame having the coupling arms respectively located at opposite ends thereof, a connection link configured to move the frame in an upward-and-downward direction, a rack unit located between the connection link and the frame, and a cylinder configured to perform movement in a height direction of the connection link.

In another preferred embodiment, the rack unit may include a rack bracket coupled to the connection link, a lift bar located on an inner side of a guide groove formed in the rack bracket, and a wire located between the lift bar and the coupling arm.

In still another preferred embodiment, the PMD module coupling structure may further include a pinion located at an end of the lift bar penetrating the guide groove and a gear part formed on the rack bracket, wherein the pinion is rotatably moved along the gear part.

In yet another preferred embodiment, the PMD module coupling structure may further include an elastic member located between the coupling arm and the frame and configured to provide elastic force in a direction in which the coupling arm is moved away from the frame.

In still yet another preferred embodiment, the pinion may be rotated, when the cylinder is driven to move the connection link in the height direction, along the gear part in a direction of unwinding the wire, and the coupling arm connected to the wire may be rotatably opened around a hinge shaft coupled to the frame.

In a further preferred embodiment, the rack bracket may be rotated so as to have a predetermined angle relative to the frame.

In another further preferred embodiment, the pinion may be rotated, when the cylinder is driven to reduce a length in the height direction of the connection link, along the gear part in a direction of winding the wire, and the coupling arms respectively connected to the wires may be rotated around respective hinge shafts coupled to the frame in a direction allowing opposite ends of the coupling arms to be closer to each other.

In still another further preferred embodiment, the PMD module coupling structure may further include a magnetic unit adjacent to the coupling arm, the magnetic unit being located on one surface facing the PMD module.

Other aspects and preferred embodiments of the invention are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of embodiments of the invention are discussed infra.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only, and thus are not limitative of the present invention, and wherein:

FIG. 1 is a perspective view of a vehicle including a PMD module according to an embodiment of the present invention;

FIG. 2A is a diagram showing a PMD module coupling structure for a vehicle at the time of being coupled to the PMD module according to an embodiment of the present invention;

FIG. 2B is a diagram showing the PMD module coupling structure for the vehicle after being coupled to the PMD module according to an embodiment of the present invention;

FIG. 3A is a diagram showing a configuration of a lift assembly according to an embodiment of the present invention;

FIG. 3B is a diagram showing a rack bracket including a guide groove according to an embodiment of the present invention;

FIG. 3C is a diagram showing the rack bracket in a state in which the lift assembly is raised according to an embodiment of the present invention;

FIG. 3D is a diagram showing a coupling arm in a state in which the lift assembly is raised according to an embodiment of the present invention;

FIG. 4A is a diagram showing the lift assembly in a lowered state according to an embodiment of the present invention;

FIG. 4B is a diagram showing the rack bracket in a state in which the lift assembly is lowered according to an embodiment of the present invention; and

FIG. 4C is a diagram showing the coupling arm in the state in which the lift assembly is lowered according to an embodiment of the present invention.

The following reference identifiers may be used in connection with the drawings to describe various features of embodiments of the present invention:

| | |
|---|---|
| 10: Vehicle | 11: Hydrogen storage tank |
| 12: Storage space | 13: Wheel |
| 20: PMD module | 100: Lift assembly |
| 110: Coupling arm | 111: Elastic member |
| 120: Frame | 121: Through hole |
| 130: Connection link | 140: Rack unit |
| 141: Rack bracket | 142: Guide groove |
| 143: Lift bar | 144: Wire |
| 145: Pinion | 146: Gear part |
| 200: Coupling assembly | 300: Magnetic unit |
| 400: Cylinder | |

It should be understood that the appended drawings are not necessarily to scale, presenting a somewhat simplified representation of various preferred features illustrative of the basic principles of embodiments of the invention. The specific design features of embodiments of the present invention as disclosed herein, including, for example, specific dimensions, orientations, locations, and shapes, will be determined in part by the particular intended application and use environment.

In the figures, reference numbers refer to the same or equivalent parts of embodiments of the present invention throughout the several figures of the drawings.

### DETAILED DESCRIPTION OF ILLUSTRATIVE EMBODIMENTS

Hereinafter, reference will be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents, and other embodiments, which may be included within the spirit and scope of the invention as defined by the appended claims. The present embodiments are provided to more fully explain the invention to those of ordinary knowledge in the art.

Terms such as “part”, “unit”, and “module” described in the specification mean a unit configured to process at least one function or operation, and the unit may be implemented by hardware or software or a combination of hardware and software.

The terms used in the present application are used only to describe specific embodiments and are not intended to limit the present invention. Singular forms are intended to include plural forms as well, unless the context clearly indicates otherwise.

Meanwhile, in this specification, terms such as “first” and “second” are used to describe various components having the same names, and the terms are used only for the purpose of distinguishing one component from other components. The components are not limited by the terms in the following description.

Hereinafter, embodiments will be described in detail with reference to the accompanying drawings. In describing the embodiments with reference to the accompanying drawings, the same or corresponding components are denoted by the same reference numerals and overlapping descriptions thereof will be omitted.

Embodiments of the present invention relate to a coupling structure between a trailer drone capable of performing autonomous driving and a PMD module 20. The trailer drone capable of performing autonomous driving may be referred to as a “vehicle 10” in this specification. A driving method of the trailer drone may include a normal internal combustion engine driving method, a driving method through a hydrogen fuel cell, and a driving method using electric energy.

Additionally, the vehicle 10 of embodiments of the present invention is movable in the longitudinal direction of the vehicle 10 and in the width direction thereof. Preferably, the vehicle 10 of embodiments of the present invention includes an independent corner module and is freely movable in the horizontal direction and in the vertical direction.

The PMD module 20 has a configuration that specifies a container-type space, and the space may be defined in a different manner depending on the purpose of each PMD module 20. For example, the PMD module 20 may be a movable house or a container including a load. However, the purpose of the PMD module 20 disclosed in this specification is not limited.

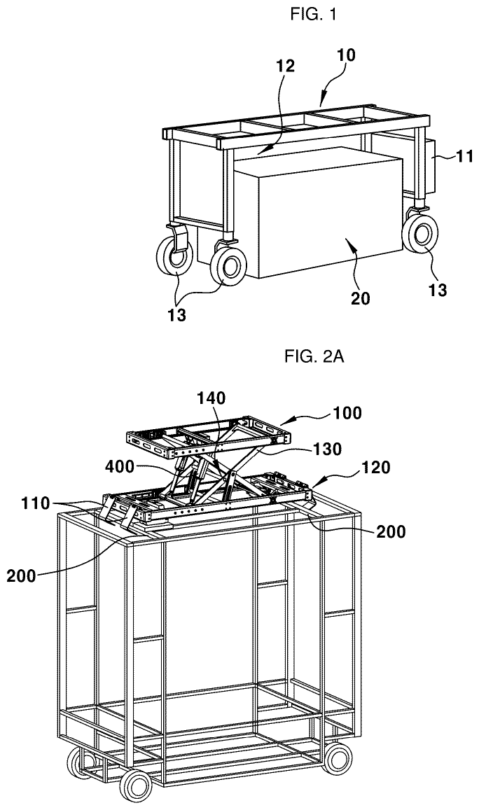

According to an embodiment of the present invention, FIG. 1 is a perspective view of a configuration in a state in which the vehicle 10 including a trailer drone and the PMD module 20 are not coupled to each other.

According to an embodiment of the present invention, the vehicle 10 may include a hydrogen fuel cell system in which the vehicle 10 is driven using hydrogen as a raw material. Here, the vehicle 10 may be driven by one or more hydrogen storage tanks 11 provided at the front and/or the rear of the vehicle 10.

As shown in the drawing, a space between wheels 13 of the vehicle 10 may form a loading space 12 into which the PMD module 20 is inserted. Here, the loading space 12 between the wheels 13 may be set in various ways depending on the size of the PMD module 20.

A PMD module coupling structure of embodiments of the present invention includes a lift assembly 100 located so as to face the upper surface of the PMD module 20 disposed in the space between the wheels 13 of the vehicle 10. The lift assembly 100 moves the PMD module 20 coupled to the vehicle 10 in the vertical direction with respect to a fixed vehicle body. Furthermore, the lift assembly 100 includes independent corner modules respectively coupled to wheels so as to be moved to a location at which the PMD module 20 is coupled to the vehicle 10.

The vehicle 10 includes the lift assembly 100 moved to allow the PMD module 20 to be located in the loading space and located in the vehicle 10 so as to face the upper surface of the PMD module 20. When the PMD module 20 is inserted into the loading space, the lift assembly 100 is moved downwards and is coupled to a coupling assembly 200 located on the upper surface of the PMD module 20.

Since the coupling assembly 200 is located on the upper surface of the PMD module 20, the coupling assembly 200 may include a coupling groove, configured to allow at least a part of the coupling arm 110 of the lift assembly 100 to be inserted thereinto, and a coupling part capable of being coupled to a magnetic unit 300 of the lift assembly 100.

After the coupling arm 110 of the lift assembly 100 is coupled to the coupling groove, a cylinder 400 is driven so as to move a connection link 130 in the height direction and, as such, the PMD module 20 is separated from the ground and is converted into a state in which the PMD module 20 is movable integrally with the vehicle 10.

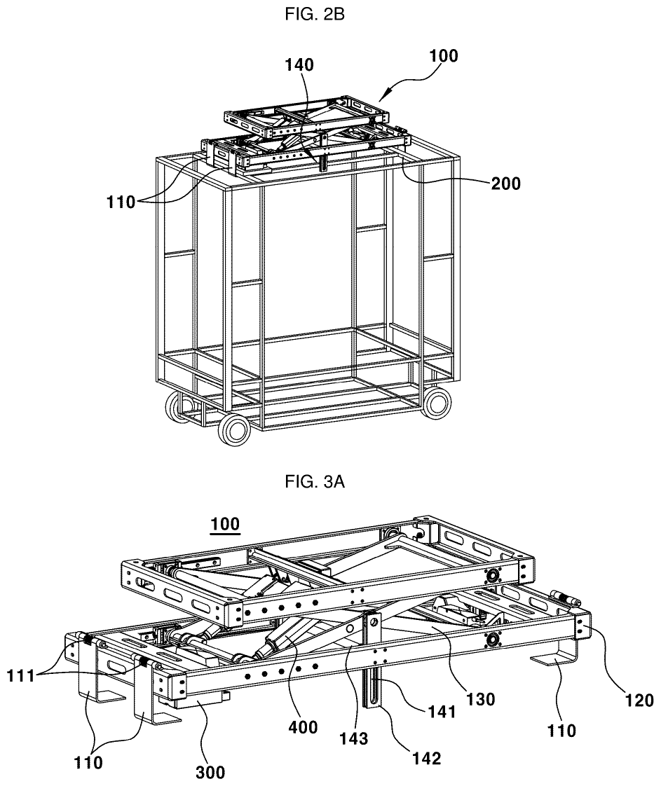

FIG. 2A is a diagram showing a state in which the lift assembly 100 is moved downwards to be coupled to the PMD module 20, and FIG. 2B is a diagram showing a state in which the lift assembly 100 coupled to the PMD module 20 is moved upwards.

As shown in FIG. 2A, the cylinder 400 of the lift assembly 100 is located in a state of being coupled to the connection link 130, and when the cylinder 400 is moved in the longitudinal direction thereof, the connection link 130 is deployed such that the PMD module 20 and a frame 120 are moved to be adjacent to each other.

The connection links 130 may have two different links respectively located on the opposite sides of the frame 120 and configured to intersect each other. The two different links are coupled to each other in an X shape and are configured to be rotated in response to movement in the longitudinal direction of the cylinder 400.

The frame 120 is located adjacent to the PMD module 20 and is configured to be moved downwards when the connection link 130 is deployed. Moreover, the lift assembly 100 includes a rack unit 140 located between the connection link 130 and the frame 120. Here, the rack unit 140 is coupled, through a wire 144, to the coupling arms 110 protruding from the opposite ends of the frame 120 in the longitudinal direction. More preferably, the coupling arm 110 is configured to be hinged to the frame 120, and the wire 144 passes through a through hole 121 of the frame 120 and is coupled to the coupling arm 110. In addition, an elastic member 111 is provided at the central axis on which the coupling arm 110 is hinged to the frame 120, in which the elastic member 111 provides elastic force in a direction in which the coupling arm 110 moves away from the frame 120.

When the connection link 130 is moved downwards, the rack unit 140 is coupled to the connection link 130 and is moved in the height direction. Moreover, a lift bar 143, having opposite ends restrained by the frame 120 and moving along the inner side of a guide groove 142 of a rack bracket 141, is rotated along a gear part 146 located on the outer surface of the rack bracket 141 in the longitudinal direction of the guide groove 142. Here, the wire 144 fixed to the lift bar 143 is configured to be rotated integrally with the lift bar 143.

According to an embodiment of the present invention, the rack unit 140 includes the rack bracket 141 configured to couple the connection link 130 to the frame 120 and the lift bar 143 configured to be moved in the longitudinal direction of the rack bracket 141 along the inner side of the guide groove 142 formed in the longitudinal direction of the rack bracket 141.

The lift bar 143 is fixed to the frame 120 and is located to protrude along the outer side of the guide groove 142 of the rack bracket 141. Here, the lift bar 143 protruding from the outer surface of the rack bracket 141 includes a pinion 145 integrally rotated with the lift bar 143.

Furthermore, the outer surface of the rack bracket 141 facing the pinion 145 includes the gear part 146 formed on the outer surface of the guide groove 142 of the rack bracket 141. Therefore, when the connection link 130 is moved in the height direction, the rack bracket 141 is moved in the height direction integrally with the connection link 130, and the pinion 145 is rotated along the gear part 146. Accordingly, the wire 144 fixed to the lift bar 143 is rotated integrally with the lift bar 143 in response to rotation of the pinion 145. More preferably, when the connection link 130 is deployed downwards, the lift bar 143 is rotated in a direction in which the wire 144 is unwound, and the end of the coupling arm 110 is located to be opened outwards from the frame 120 by the elastic member 111.

On the other hand, as shown in FIG. 2B, when the connection link 130 is raised, at least a part of the coupling arm 110 is inserted into the coupling assembly 200, thereby maintaining a state in which the magnetic unit 300 is fixed to the coupling part.

That is, when the cylinder 400 applies force that is reduced in the longitudinal direction thereof to the connection link 130, the connection link 130 coupled to the cylinder 400 is moved to a location at which a height in the vertical direction of the connection link 130 is reduced. When the height of the connection link 130 is reduced, the rack bracket 141, one end of which is located on the central axis of the connection link 130, is integrally moved in response to movement of the connection link 130 in the height direction.

Furthermore, the lift bar 143, located on the inner side of the guide groove 142 of the rack bracket 141 and configured to allow the opposite sides thereof to be coupled to the frame 120, is moved to face the upper inner end of the guide groove 142. In addition, the pinion 145 formed to be integrated with the lift bar 143 is rotated along the gear part 146 located on the outer surface of the rack bracket 141, and the wire 144 fixed to the lift bar 143 is configured to be wound around the lift bar 143.

Accordingly, the end of the wire 144 connected to the coupling arm 110 is moved in a direction closer to the lift bar 143. Here, the coupling arms 110 respectively located at the opposite ends of the frame 120 are rotated in a direction allowing opposite ends thereof to be closer to each other with respect to the frame 120. Accordingly, at least a part of the coupling arm 110 is inserted into a coupling hole of the coupling assembly 200, thereby maintaining a state in which the PMD module 20 is fixed to the lift assembly 100.

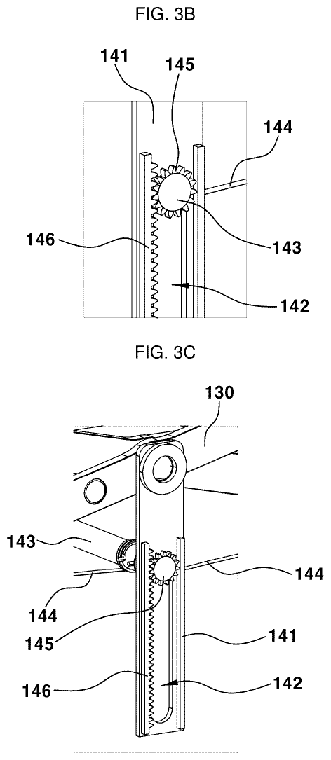

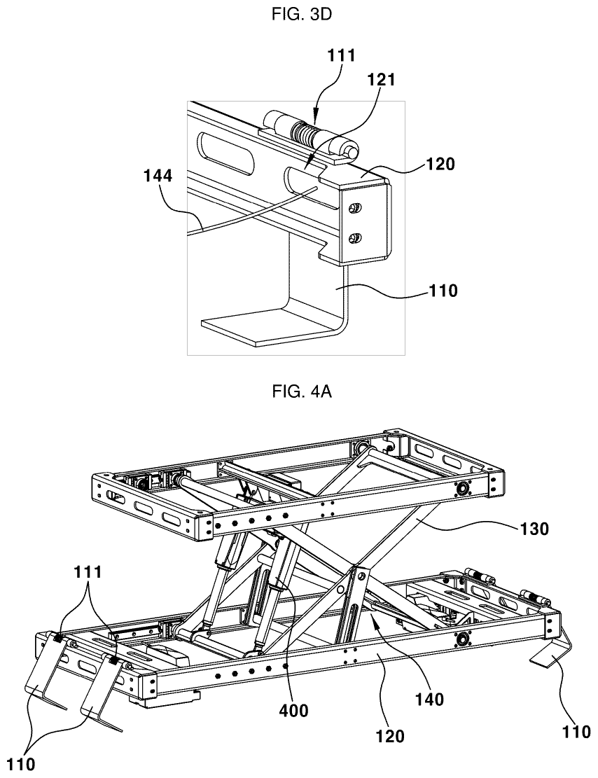

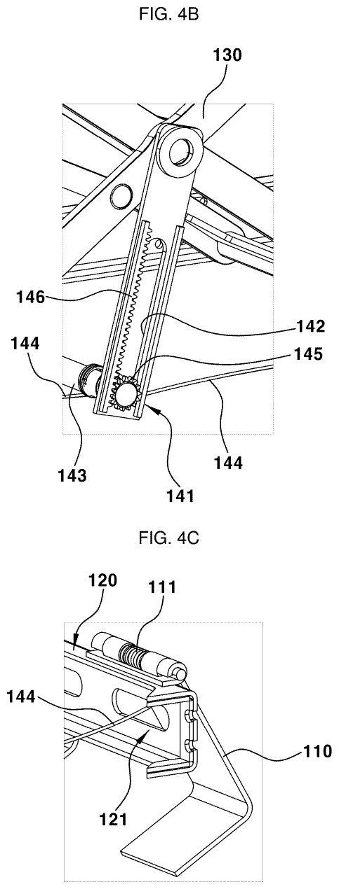

FIGS. 3A to 3D show a coupling relationship between components in a state in which the lift assembly 100 is raised, and FIGS. 4A to 4C show a coupling relationship between components in a state in which the lift assembly 100 is lowered.

Here, FIG. 3A shows a configuration in which the lift assembly 100 is raised and the width of the connection link 130 is maximally reduced.

As shown in the drawing, when the cylinder 400 coupled to the connection link 130 is driven to have a minimum length thereof, the connection link 130 is located so as to have the minimum vertical width thereof. The connection links 130 are respectively disposed at the opposite sides of the frame 120 and are symmetrical to each other, and each of the connection links 130 has two links intersecting each other with respect to one central axis.

Furthermore, one end of the rack bracket 141 is located on the central axis of the connection link 130, and the other end thereof is located to protrude from the lower end of the frame 120. The guide groove 142 formed in the rack bracket 141 has the lift bar 143 disposed at the inner side thereof and configured to be freely rotatable in a state in which the opposite ends thereof are restrained by the frame 120. Furthermore, the lift bar 143 includes the pinions 145 respectively penetrating the guide grooves 142 of the rack brackets 141 respectively located on the opposite sides of the frame 120 and respectively protruding from the outer surfaces of the rack brackets 141.

More preferably, the lift bar 143 has an end protruding through the guide groove 142 of the rack bracket 141, and the end may be restrained by a groove (not shown) located on the inner side of the frame 120.

In addition, the rack unit 140 includes the wire 144 having one end coupled to the coupling arm 110 and the other end located on the lift bar 143. The wire 144 is configured to be wound around the lift bar 143 or unwound therefrom in response to rotation of the lift bar 143. More preferably, when the lift bar 143 is rotated in a direction in which the wire 144 is wound around the lift bar 143, the coupling arms 110 respectively located at the opposite ends in the longitudinal direction of the frame 120 are configured to be rotated in a direction allowing the opposite ends thereof to be adjacent to each other with respect to the frame 120. In this manner, when the connection link 130 is moved so as to have a minimum height, the rack bracket 141 is located to protrude from the lower end of the frame 120, and a direction in which the pinion 145 is rotated along the gear part 146 is a direction in which the wire 144 is wound around the lift bar 143.

Conversely, when the connection link 130 is moved to have a maximum height, the wire 144 is configured to be unwound from the lift bar 143. That is, the rack bracket 141 is raised integrally with the central axis of the connection link 130, and the pinion 145 is rotated along the gear part 146. In this case, the wire 144 is rotated in a direction of being unwound from the lift bar 143. Here, the coupling arms 110 respectively coupled to the wires 144 may be rotated in a direction in which the opposite ends of the coupling arms 110 are moved away from each other by elastic force of the elastic member 111.

As shown in FIGS. 3B and 3C, in a state in which the lift assembly 100 is raised, the pinion 145 located on the lift bar 143 is engaged with the gear part 146 formed in the longitudinal direction of the guide groove 142 provided in the outer surface of the rack bracket 141, and the pinion 145 is configured to be located on one side of the upper end of the guide groove 142.

In addition, as shown in FIG. 3D, the lift bar 143 to which the wire 144 is coupled is rotated in a direction in which the wire 144 is wound, and tension is configured to be applied to the coupling arm 110 by the wound wire 144. Accordingly, a hook area of the coupling arm 110 is inserted into the coupling groove of the coupling assembly 200, thereby providing a mechanical fixing structure.

That is, when the cylinder 400 has a minimum length, the rack bracket 141 is configured to protrude downwards relative to the frame 120, and the wire 144 is rotated in a direction in which the wire 144 is wound around the lift bar 143 such that the hook areas of the coupling arms 110 switch to positions at which the hook areas of the coupling arms 110 are adjacent to each other. Accordingly, at least a part of the coupling arm 110 is inserted and fixed into the coupling assembly 200 in a direction in which the wire 144 is wound.

FIG. 4A shows a configuration of the lift assembly 100 when the cylinder 400 is deployed in the longitudinal direction.

When the PMD module 20 and the vehicle 10 are disconnected, or when the lift assembly 100 is deployed to the first PMD module 20, the cylinder 400 is configured to extend in the longitudinal direction. In response to deployment of the cylinder 400, the connection link 130 is deployed in the height direction.

As shown in FIG. 4B, the rack bracket 141, one end of which is located on the central axis of the connection link 130, is integrally moved in response to movement of the connection link 130 in the height direction. Additionally, the other end of the rack bracket 141 is moved to a position corresponding to the height of the frame 120. In addition, the pinion 145 is moved along the gear part 146 and is moved to a position at which the pinion 145 is in contact with the lower inner end of the guide groove 142. When located at the lower inner end of the guide groove 142, the rack bracket 141 is rotated around one end thereof coupled to the connection link 130. Accordingly, in a state in which the connection link 130 is fully deployed, the rack bracket 141 is obliquely located so as to have a predetermined angle relative to the frame 120. When the rack bracket 141 is obliquely located relative to the frame 120, the lift bar 143 may be moved along the groove formed on the inner side of the frame 120.

That is, when the connection link 130 is raised and one end of the rack bracket 141 is raised, the other end of the rack bracket 141 is moved by a predetermined distance along the groove of the frame 120, and when the pinion 145 is located on the lower inner end of the guide groove 142, the rack bracket 141 is obliquely located so as to have a predetermined angle relative to the frame 120.

FIG. 4C shows a configuration of the coupling arm 110 in a state in which the connection link 130 is moved so as to have a maximum distance in the vertical direction.

When the connection link 130 has a maximum distance, the pinion 145 located on the lift bar 143 is rotatably moved so as to contact one side of the lower end of the guide groove 142 of the rack bracket 141. Moreover, when the lift bar 143 is rotatably moved to one side of the lower end of the guide groove 142, the lift bar 143 is rotated in a direction of unwinding the wire 144. Accordingly, the coupling arms 110, respectively coupled to the wires 144 and respectively provided at the opposite ends of the frame 120, are freely movable. More preferably, the coupling arms 110 hinged to the frame 120 receive elastic force from the elastic members 11 in a direction in which the coupling arms 110 respectively located at the opposite ends of the frame 120 are opened outwards. Accordingly, when tension of the wire 144 is removed, the coupling arms 110 are maintained in a state of being deployed in the left-and-right direction with respect to the frame 120.

That is, the lift bar 143 is rotated in a direction in which the wire 144 is unwound in conjunction with the rack bracket 141 that is moved upwards and downwards integrally with the connection link 130. The coupling arm 110 coupled to the wire 144 is converted into a deployed state in a direction in which the coupling arm 110 is moved away from the frame 120 by elastic force.

As described above, FIGS. 4A to 4C show a state in which the lift assembly 100 is spaced apart from the PMD module 20 or a state in which the lift assembly 100 is inserted into the PMD module 20.

As is apparent from the above description, embodiments of the present invention may achieve the following effects through the embodiments, a combination of the above-described configurations, and a use relationship therebetween.

Embodiments of the present invention provide a mechanical coupling structure between a coupling assembly and a lift assembly, thereby achieving a structural robustness effect.

Additionally, embodiments of the present invention provide a double coupling structure between the coupling assembly of a PMD module and the lift assembly located on a vehicle body, thereby having an effect of strengthening a coupling structure between components.

Embodiments of the present invention have been described in detail with reference to preferred embodiments thereof, and the embodiments of the present invention may be used in various other combinations, modifications, and environments. That is, it will be appreciated by those skilled in the art that changes may be made in these embodiments without departing from the principles and spirit of the invention, the scope of which is defined in the appended claims and equivalents thereto. The embodiments describe the best mode to implement the technical idea of the present invention, and various changes required in specific application fields and uses of the present invention are also possible. Accordingly, the detailed description of the embodiments of the present invention is not intended to limit the present invention to the disclosed embodiments. Additionally, the scope of the appended claims should be construed as including other embodiments as well.

What is claimed is:

1. A power mobility device (PMD) module coupling structure for a vehicle, the structure comprising:
a coupling assembly disposed on a PMD module; and
a lift assembly disposed on a vehicle body facing an upper end of the PMD module so as to correspond to the coupling assembly, wherein a part of the lift assembly is insertable into the coupling assembly to mutually fix the PMD module and the lift assembly to each other.

2. The structure of claim 1, wherein the lift assembly comprises:
coupling arms, each of the coupling arms being inserted into the coupling assembly at a location corresponding to the coupling assembly;
a frame having the coupling arms respectively disposed at opposite ends thereof;
a connection link configured to move the frame in an upward-and-downward direction;
a rack unit located between the connection link and the frame; and
a cylinder configured to perform movement in a height direction of the connection link.

3. The structure of claim 2, further comprising elastic members respectively disposed between the coupling arms and the frame and configured to provide elastic force in a direction in which the respective coupling arm is moved away from the frame.

4. The structure of claim 2, further comprising magnetic units respectively disposed adjacent to the coupling arms, the magnetic units being disposed on a surface facing the PMD module.

5. The structure of claim 2, wherein the rack unit comprises:
a rack bracket coupled to the connection link;
a lift bar disposed on the frame and configured to penetrate a guide groove disposed in the rack bracket; and
a wire disposed between the lift bar and the respective coupling arm.

6. The structure of claim 5, further comprising:
a pinion located at an end of the lift bar penetrating the guide groove; and
a gear part disposed on the rack bracket, wherein the pinion is rotatably movable along the gear part.

7. The structure of claim 6, wherein, in a state in which the cylinder is driven to move the connection link in the height direction, the pinion is rotated along the gear part in a direction of unwinding the wire.

8. The structure of claim 7, wherein the coupling arm connected to the wire is configured to be rotatably opened around a hinge shaft coupled to the frame.

9. The structure of claim 7, wherein the rack bracket is configured to be rotated to have a predetermined angle relative to the frame.

10. The structure of claim 6, wherein, in a state in which the cylinder is driven to reduce a length in the height direction of the connection link, the pinion is rotated along the gear part in a direction of winding the wire.

11. The structure of claim 10, wherein the coupling arms respectively connected to the wires are rotated around respective hinge shafts coupled to the frame in a direction allowing opposite ends of the coupling arms to be closer to each other.

12. A power mobility device (PMD) module coupling structure for a vehicle, the structure comprising:
the vehicle comprising a loading space between wheels;
a PMD module insertable into the loading space of the vehicle;
a coupling assembly disposed on the PMD module; and
a lift assembly disposed on a vehicle body of the vehicle facing an upper end of the PMD module so as to correspond to the coupling assembly, wherein a part of the lift assembly is insertable into the coupling assembly to mutually fix the PMD module and the lift assembly to each other.

13. The structure of claim 12, wherein the lift assembly comprises:
coupling arms, each of the coupling arms being inserted into the coupling assembly at a location corresponding to the coupling assembly;
a frame having the coupling arms respectively disposed at opposite ends thereof;
a connection link configured to move the frame in an upward-and-downward direction;
a rack unit located between the connection link and the frame; and
a cylinder configured to perform movement in a height direction of the connection link.

14. The structure of claim 13, further comprising elastic members respectively disposed between the coupling arms and the frame and configured to provide elastic force in a direction in which the respective coupling arm is moved away from the frame.

15. The structure of claim 13, further comprising magnetic units respectively disposed adjacent to the coupling arms, the magnetic units being disposed on a surface facing the PMD module.

16. The structure of claim 13, wherein the rack unit comprises:
a rack bracket coupled to the connection link;
a lift bar disposed on the frame and configured to penetrate a guide groove disposed in the rack bracket; and
a wire disposed between the lift bar and the respective coupling arm.

17. The structure of claim 16, further comprising:
a pinion located at an end of the lift bar penetrating the guide groove; and
a gear part disposed on the rack bracket, wherein the pinion is rotatably movable along the gear part.

18. The structure of claim 17, wherein, in a state in which the cylinder is driven to move the connection link in the height direction, the pinion is rotated along the gear part in a direction of unwinding the wire.

19. The structure of claim 17, wherein, in a state in which the cylinder is driven to reduce a length in the height direction of the connection link, the pinion is rotated along the gear part in a direction of winding the wire.

20. The structure of claim 19, wherein the coupling arms respectively connected to the wires are rotated around respective hinge shafts coupled to the frame in a direction allowing opposite ends of the coupling arms to be closer to each other.
